(19) United States
(12) Patent Application Publication
(10) Pub. No.: US 2019/0187800 A1
(43) Pub. Date: Jun. 20, 2019

(54) BACKLIGHT EMBEDDED INFRARED PROXIMITY SENSING AND GESTURE CONTROL

(71) Applicant: Panasonic Automotive Systems Company of America, Division of Panasonic Corporation of North America, Peachtree City, GA (US)

(72) Inventors: ALEXANDER KLEMENT, NEWNAN, GA (US); COREY METSKER, TYRONE, GA (US)

(73) Assignee: Panasonic Automotive Systems Company of America, Division of Panasonic Corporation of North America

(21) Appl. No.: 16/222,327

(22) Filed: Dec. 17, 2018

Related U.S. Application Data
(60) Provisional application No. 62/607,502, filed on Dec. 19, 2017.

(51) Int. Cl. G06F 3/01; G02F 1/1333

(52) U.S. Cl. CPC G06F 3/017; G02F 2203/11; G02F 1/133308; G02F 1/13338

(57) ABSTRACT

A motor vehicle includes a display screen having a plurality of light emitting diodes emitting visible light and at least one infra-red energy-emitting element. An infra-red photo detector receives infra-red energy emitted by the infra-red energy-emitting element and reflected by a person within a passenger compartment of the motor vehicle. An electronic processor is communicatively coupled to the infra-red photo detector. The electronic processor receives signals from the infra-red photo detector. The electronic processor determines, based on the signals, a position of a body part of the person within the passenger compartment of the motor vehicle.

### CROSS-REFERENCED TO RELATED APPLICATIONS

This application claims benefit of U.S. Provisional Application No. 62/607,502 filed on Dec. 19, 2017, which the disclosure of which is hereby incorporated by reference in its entirety for all purposes.

### FIELD OF THE INVENTION

The disclosure relates to proximity sensing and gesture control in a motor vehicle.

### BACKGROUND OF THE INVENTION

Proximity sensing and gesture control are becoming more popular in consumer devices. Several cellular phone manufactures offer gesture control options.

Currently there are several approaches for proximity sensing methods. One such method involves using a camera. Advantages of a camera is that it has good range, and enables superior gesture sensing. A disadvantage of a camera is that it is expensive. Another method for proximity sensing involves using analyzing sound. Although this technique has great potential, it is not a proven technology.

### SUMMARY

According to the present invention, a vehicle may include an infra-red light source incorporated into a display to perform proximity and gesture recognition. Using infra-red energy as a standalone solution for proximity sensing is inexpensive and easy to implement. However, the range of infra-red is limited by the power of the light source. Also, the use of infra-red energy requires dedicated LEDs, which occupies additional space under the dashboard.

In one embodiment, the invention comprises a motor vehicle including a display screen having a plurality of light emitting diodes emitting visible light. The display screen also has at least one infra-red energy-emitting element. An infra-red photo detector receives infra-red energy emitted by the infra-red energy-emitting element and reflected by a person within a passenger compartment of the motor vehicle. An electronic processor is communicatively coupled to the infra-red photo detector. The electronic processor receives signals from the infra-red photo detector. The electronic processor determines, based on the signals, a position of a body part of the person within the passenger compartment of the motor vehicle.

In another embodiment, the invention comprises a method for operating a motor vehicle, including providing a display screen having a plurality of light emitting diodes emitting visible light, and at least one infra-red energy-emitting element. An infra-red photo detector is used to receive infra-red energy emitted by the infra-red energy-emitting element and reflected by a person within a passenger compartment of the motor vehicle. Signals are received from the infra-red photo detector. It is determined, based on the signals, a position of a body part of the person within the passenger compartment of the motor vehicle.

In yet another embodiment, the invention comprises a display screen including a plurality of white light emitting diodes emitting white light, and a plurality of infra-red light emitting diodes emitting infra-red energy. A bezel surrounds the white light emitting diodes and the infra-red light emitting diodes. A plurality of infra-red photo detectors are spaced apart on the bezel. Each of the infra-red photo detectors receives infra-red energy that is emitted by the infra-red light emitting diodes and that is reflected by a person disposed in front of the display screen.

The present invention may enable proximity sensing to be performed at the same high level of camera-based systems while occupying a relatively small amount of space and being relatively inexpensive.

The proximity sensing system of the present invention may be a part of the display assembly, and may have an infra-red transmitter that is a part of the backlight circuit. This provides the transmitter with greater power and thus enables a greater amount of infra-red light to be emitted, which results in superior performance.

### BRIEF DESCRIPTION OF THE DRAWINGS

A better understanding of the present invention will be had upon reference to the following description in conjunction with the accompanying drawings.

FIG. 1 is a diagram of one embodiment of a sub-pixel arrangement of the present invention for a display screen.

FIG. 2 is a diagram of one embodiment of a liquid crystal display arrangement of the present invention.

FIG. 3 is a timing diagram for energization of the white LEDs and IR LEDs of FIG. 2 according to one embodiment.

FIG. 4 is a flow chart of one embodiment of a method of the present invention for operating a motor vehicle.

### DETAILED DESCRIPTION OF THE PREFERRED EMBODIMENTS

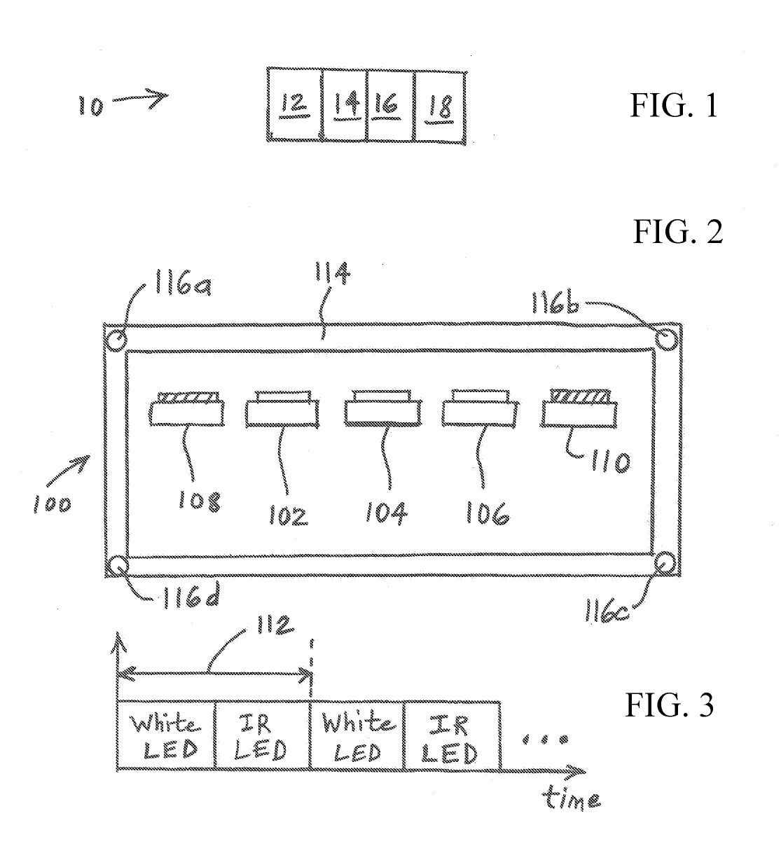

FIG. 1 illustrates one embodiment of a sub-pixel arrangement 10 of the present invention for a display screen. Arrangement 10 forms a pixel having three sub-pixels, including a red sub-pixel 12, a green sub-pixel 14, and a blue sub-pixel 16. Arrangement 10 also has an infra-red (IR) transmitter 18 which may have the size, placement and shape of a sub-pixel, but which transmits infra-red energy out of the display screen. It is possible to use any pixel arrangement including sub pixels creating colors (e.g., the sub-pixels are not limited to red, green, blue) and an infra-red component.

FIG. 2 illustrates one embodiment of a liquid crystal display arrangement 100 of the present invention, having five aligned light-emitting diodes (LEDs), including three white LEDs 102, 104, 106 in the middle, and two IR LEDs 108, 110 on the ends. IR LEDs 108, 110 may be driven independently of the other LEDs 102, 104, 106. IR signals may be transmitted by IR LEDs 108, 110 between normal video frames. This arrangement may be applied to LCDs, OLED displays, or any displays developed in the future.

The number of IR LEDs and the physical arrangement of the LEDs can vary within the scope of the invention based on the display resolution and other design requirements. Local dimming can be used to improve the performance of the IR LEDs. The IR LEDs can also be time multiplexed and may work together with the white LEDs.

The IR LEDs can be physically arranged in any pattern with the white LEDs. Both the IR LEDs and the white LEDs can be enabled, or turned ON, at the same time. It is also possible for the IR LEDs and the white LEDs to be driven at different times. The time duration and duty cycle of the ON/OFF cycle can be adjusted to meet requirements. When the display is off (e.g., when the display is not showing any image) the IR LEDs can be still enabled and the IR subpixel can be programmed to be in the open position when the display is off.

FIG. 3 illustrates the timing of energization of white LEDs 102, 104, 106 and IR LEDs 108, 110 according to one embodiment. The time duration of one frame 112, including both energizing of the white LEDs and a subsequent energizing of the IR LEDs, may be about 16.667 milliseconds in one embodiment.

Referring again to FIG. 2, liquid crystal display arrangement 100 may include a rectangular bezel 114 having four IR photo detectors 116a-d, one IR photo detector being at each of the four corners of bezel 114. The number of IR photo detectors and their locations and positions can vary based on the design requirements.

The present invention has several benefits. First, there is no need for a dedicated space for IR hardware. Thus, there is a better utilization of space. Second, the gesture detection area and distance can be controlled by the amount of the IR light coming out of the display. Third, the total cost is low and is on par with current IR solutions.

During use, IR LEDs 108, 110 emit IR energy into the passenger compartment of the motor vehicle. The IR energy reflects off of the human passengers within the passenger compartment and back toward liquid crystal display arrangement 100. IR photo detectors 116a-d detect the reflected IR energy. An electronic processor (not shown) receives signals from IR photo detectors 116a-d and determines based thereon the positions, locations, movements, and gestures of the passengers of the motor vehicle.

Although the IR photo detectors are shown as being disposed on a bezel of the display screen, it is to be understood that it is also possible within the scope of the invention for the IR photo detectors to be disposed off of or beside the display screen.

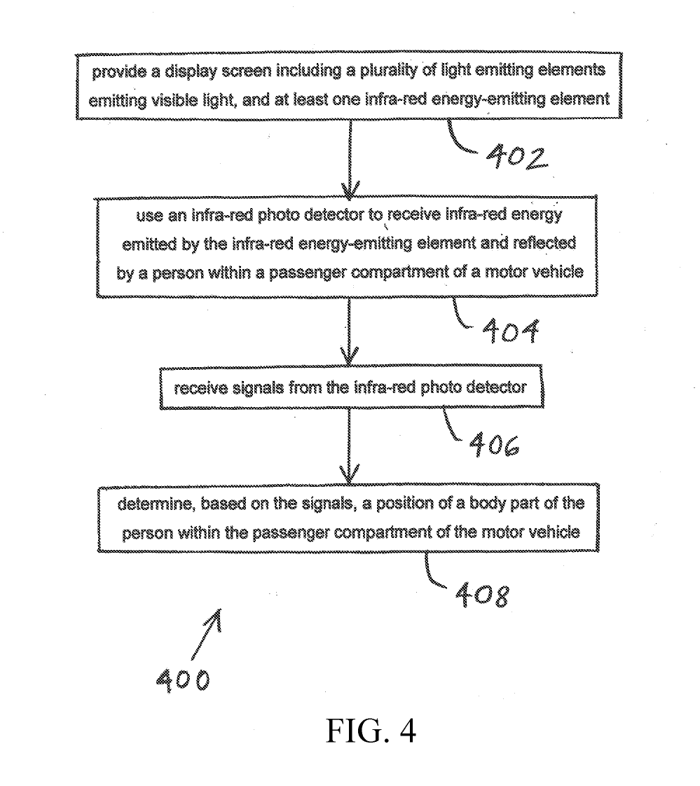

FIG. 4 illustrates one embodiment of a method 400 of the present invention for operating a motor vehicle. In a first step 402, a display screen is provided including light emitting elements emitting visible light, and at least one infra-red energy-emitting element. For example, liquid crystal display arrangement 100 includes visible light-emitting diodes (LEDs) in the form of three white LEDs 102, 104, 106, and infra-red energy-emitting LEDs 108, 110.

Next, in step 404, an infra-red photo detector is used to receive infra-red energy emitted by the infra-red energy-emitting element and reflected by a person within a passenger compartment of the motor vehicle. For example, IR photo detectors 116a-d detect the IR energy reflected off of the human passengers within the passenger compartment and back toward liquid crystal display arrangement 100.

In a next step 406, signals are received from the infra-red photo detector. For example, an electronic processor receives signals from IR photo detectors 116a-d.

In a final step 408, a position of a body part of the person within the passenger compartment of the motor vehicle is determined based on the signals. For example, the electronic processor determines, based on the received signals, the positions, locations, movements, and gestures of the passengers of the motor vehicle.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
a display screen including:
a plurality of light emitting elements emitting visible light; and
at least one infra-red energy-emitting element;
at least one infra-red photo detector configured to receive infra-red energy emitted by the infra-red energy-emitting element and reflected by a person within a passenger compartment of the motor vehicle; and
an electronic processor communicatively coupled to the infra-red photo detector, the electronic processor being configured to:
receive signals from the infra-red photo detector; and
determine, based on the signals, a position of a body part of the person within the passenger compartment of the motor vehicle.

2. The motor vehicle of claim 1 wherein the light emitting elements comprise three light emitting diodes emitting red light, green light and blue light, respectively, the three light emitting diodes and the at least one infra-red energy-emitting element being in a same pixel of the display screen.

3. The motor vehicle of claim 1 wherein the light emitting elements emit white light.

4. The motor vehicle of claim 1 wherein the display screen includes a bezel, the infra-red photo detector being disposed on the bezel.

5. The motor vehicle of claim 4 wherein the bezel is rectangular and has four corners, the infra-red photo detector being disposed on one of the corners.

6. The motor vehicle of claim 5 wherein the at least one infra-red photo detector comprises four infra-red photo detectors, each of the four infra-red photo detectors being disposed on a respective said corner of the bezel.

7. The motor vehicle of claim 1 wherein the electronic processor is configured to recognize, based on the signals, a hand gesture of the person within the passenger compartment of the motor vehicle.

8. A method for operating a motor vehicle, the method comprising:
providing a display screen including:
a plurality of light emitting elements emitting visible light; and
at least one infra-red energy-emitting element;
using an infra-red photo detector to receive infra-red energy emitted by the infra-red energy-emitting element and reflected by a person within a passenger compartment of the motor vehicle;
receiving signals from the infra-red photo detector; and
determining, based on the signals, a position of a body part of the person within the passenger compartment of the motor vehicle.

9. The method of claim 8 wherein the light emitting elements comprise three light emitting diodes emitting red light, green light and blue light, respectively, the three light emitting diodes and the at least one infra-red energy-emitting element being in a same pixel of the display screen.

10. The method of claim 8 wherein the light emitting elements emit white light.

11. The method of claim 8 wherein the display screen includes a bezel, the infra-red photo detector being disposed on the bezel.

12. The method of claim 11 wherein the bezel is rectangular and has four corners, the infra-red photo detector being disposed on one of the corners.

13. The method of claim 12 wherein the at least one infra-red photo detector comprises four infra-red photo detectors, each of the four infra-red photo detectors being disposed on a respective said corner of the bezel.

14. The method of claim 8 further comprising recognizing, based on the signals, a hand gesture of the person within the passenger compartment of the motor vehicle.

15. A display screen including:
a plurality of white light emitting elements emitting white light;
a plurality of infra-red light emitting elements emitting infra-red energy;
a bezel surrounding the white light emitting elements and the infra-red light emitting elements; and
a plurality of infra-red photo detectors spaced apart on the bezel, each of the infra-red photo detectors being configured to receive infra-red energy that is emitted by the infra-red light emitting elements and that is reflected by a person disposed in front of the display screen.

16. The display screen of claim 15 further comprising an electronic processor communicatively coupled to the infra-red photo detectors, the electronic processor being configured to:
receive signals from the infra-red photo detectors; and
determine, based on the signals, a position of a body part of the person within the passenger compartment of the motor vehicle.

17. The display screen of claim 16 wherein the electronic processor is communicatively coupled to the white light emitting elements, the electronic processor being configured to cause the white light emitting elements to alternatingly emit the white light and cause the infra-red light emitting elements to alternatingly emit the infra-red energy such that only one of the white light and the infra-red energy is emitted at any point in time.

18. The display screen of claim 16 wherein the electronic processor is configured to recognize, based on the signals, a hand gesture of the person within the passenger compartment of the motor vehicle.

19. The display screen of claim 16 wherein the electronic processor is communicatively coupled to the white light emitting elements, the electronic processor being configured to cause the white light emitting elements to alternatingly emit the white light and cause the infra-red light emitting elements to alternatingly emit the infra-red energy in cycles, each said cycle including the white light emitting elements emitting white light one time and the infra-red light emitting elements emitting the infra-red energy one time, each said cycle having a time duration of approximately between one millisecond and one hundred milliseconds.

20. The display screen of claim 15 wherein the bezel is rectangular and has four corners, the infra-red photo detectors including four infra-red photo detectors, each of the four infra-red photo detectors being disposed on a respective one of the corners.
